(19) United States
(12) Patent Application Publication
(10) Pub. No.: US 2009/0065722 A1
(43) Pub. Date: Mar. 12, 2009

(54) PRESSURE CONTROL VALVE

(75) Inventors: Thilo Schmidt, Meckenbeuren (DE); Markus Moosmann, Ravensburg (DE); Karlheinz Mayr, Bregenz (AT)

Correspondence Address: Davis Bujold & Daniels, P.L.L.C., 112 Pleasant Street, Concord, NH, 03301-2931, US

(73) Assignee: ZF Friedrichshafen AG, Friedrichshafen (DE)

(21) Appl. No.: 12/197,479

(22) Filed: Aug. 25, 2008

(30) Foreign Application Priority Data
Sep. 8, 2007 (DE) 10 2007 042 890.3

(51) Int. Cl. F16K 31/02

(52) U.S. Cl. 251/129.14

(57) ABSTRACT

A pressure control valve having valve seats, an electromagnet, a magnetic coil, and an armature coupled to an anchor rod, which are axially slidable for biasing a part against a first valve seat to close a tank edge. A push rod, which is integral with the anchor rod, biases a locking element off a ball seat to open an inlet control edge. The cross-section of the inlet control edge can be modified depending on the temperature such that the cross-section is opened as widely as possible at low oil temperatures. The cross-section of the inlet control edge is reduced at high oil temperatures to the extent that a high valve dynamic of the follow-up slide valve is achieved, and the leakage oil flow is not significantly increased.

This application claims priority from German Application Serial No. 10 2007 042 890.3 filed Sep. 8, 2007.

### FIELD OF THE INVENTION

The invention concerns a pressure control valve.

### BACKGROUND OF THE INVENTION

It is generally known from the prior art to utilize wet-running disk shifting elements for torque transmission in automatic transmissions of motor vehicles.

Here torque transmission is effected in a friction-driven manner by pressing on the disk sets of the shifting elements wherein, for this purpose, the required contact pressure on the disk set is generated via a hydraulically operated clutch piston, which is actuated via a pressure control valve (clutch valve). The pressure control valves of the shifting elements are either directly actuated or controlled via pressure limiting valves or precontrol valves connected upstream.

A magnetic force, which is generated in both cases, is proportional to the control current and by way of which the purely hydraulic pressure control valves of the shifting element are shifted. The working pressure of the clutch valves is produced by the equilibrium condition of the force that is proportional to the control current (=actuating force) and the return force (=reaction force) of the pressure control valve.

A closed-end pressure regulator (CE-DR), which features two valve seats arranged in hydraulic half-bridge circuit, wherein a ball seat geometry is used at the inlet side and a flat or ball seat geometry is used on the tank side, is frequently used according to the prior art for control in the case in which the pressure control valve is controlled via a pressure regulator connected upstream or via a pressure limiting valve (precontrol valve) connected upstream.

In an advantageous manner, a closed-end pressure regulator allows minimization of leakage oil flow in the end positions. At the desired minimal pressure, the inlet control edge is closed and the leakage oil flow from the inlet control edge to the tank edge is thus reduced to almost 0 ml/min. This is necessary, because one actuator should ideally be directly associated with each shifting element of an automatic transmission in order to be able to represent each possible shift change.

Without the closed-end function, each precontrol valve would have a maximum leakage between the inlet edge and the tank edge at minimal pressure requirement. With a large quantity of shifting elements to be controlled, the result would thus be a very high oil volume requirement in the hydraulic system of the vehicle's hydraulic pump

A precontrol valve such as this is known from DE 10342892 A1 of the Applicant. A proportional pressure limiting valve with a magnetic part and a valve part is described within the scope of DE 10342892 A1, wherein the valve part is provided with an inlet opening for the inlet volume flow, a first outlet opening for the filling volume flow and a second outlet opening for the tank volume flow and a ball seat, a flat seat provided with an opening, a closing part for controlling the flow rate through the opening of the flat seat and a stream diverter arranged between the ball seat and the flat seat.

WO 98/48332 of the Applicant also discloses a pressure control valve configured as closed-end pressure regulator, having a connection for a pressure line, a connection for a working pressure line and a connection for an outlet line to the ambient pressure and at least two aperture stages with defined and definable flow resistance, of which two aperture stages are variably coupled under mechanical or hydraulic action according to the principle of the hydraulic half bridge. Both variable aperture stages are provided as inlet and outlet apertures of a control pressure chamber and feature a sealing element, wherein the sealing element of the inlet aperture is configured as a ball or calotte or truncated cone or cylinder and/or the sealing element of the outlet aperture is configured as a ball or calotte or truncated cone or cylinder.

The current embodiment of the pressure control valves configured as a closed-end pressure regulator, has the problem that at low oil temperatures the inlet volume flow is greatly reduced due to the viscous behavior of the oil, which in a disadvantageous manner leads to a reduction of the valve dynamic, in particular in precontrolled clutch valves. Compensating for this effect by way of a larger inlet geometry has proven to be disadvantageous, since the leakage volume flow is greatly increased at high temperatures.

It is therefore an object of the present invention to disclose a pressure control valve configured as a closed-end pressure regulator, in which a sufficient inlet volume flow is also ensured at low oil temperatures, without the disadvantage of a greatly increased leakage volume flow at high temperatures.

### SUMMARY OF THE INVENTION

A pressure control valve configured as a closed-end pressure regulator is accordingly proposed in which the cross-section of the inlet control edge (that is, the valve or ball seat) can be modified depending on the temperature in such a way that the cross-section is opened as widely as possible at low oil temperatures in order to make a large volume flow to the follow-up slide valves possible, while the cross-section of the inlet control edge is reduced at high oil temperatures such that a high valve dynamic of the follow-up slide valve is achieved and the leakage oil flow is not significantly increased.

Within the scope of a particularly advantageous embodiment of the invention, it is proposed that the ball seat be designed from a material whose heat expansion coefficient is considerably greater than the heat expansion coefficient of the push rod and which thus features a disproportionately greater geometric expansion in comparison with the material of the push rod at increasing temperatures. This ensures that the cross-section of the inlet control edge has an ever-smaller cross-section surface at increasing temperature.

The cross-section reduction in a circular cross-section is proportional to the square of the temperature, since the diameter of the cross-section is linearly reduced with the temperature and the surface of the cross-section and thus the flow through the cross-section are related to the square of the cross-sectional diameter.

According to a particularly advantageous further development of the invention, the ball seat is formed by an annular disk, wherein a stable supporting ring that is mounted in a fixed manner in a housing is provided on the outer diameter of the disk such that the thermal expansion of the annular disk is guided inward as viewed from the radial direction.

The supporting ring is preferably made of a material that has approximately the same heat expansion coefficient as the material of the push rod, whereby the cross-section of the inlet control edge can be determined in an advantageous way by selection of the material for the annular disk that forms the ball seat.

According to the invention, the annular disk that forms the ball seat can be composed of a plastic material which features non-linear heat expansion behavior above the glass transition point with a disproportionate reduction of the cross-section of the inlet control edge above the glass transition point of the plastic can be achieved in this way by utilizing a polyphenylene sulfide (PPS plastic); a typical value being around 80° C.

According to another embodiment of the invention, a material having a negative heat expansion coefficient, such as a GFK material (fiberglass-reinforced plastic) can be used for the ball seat as an alternative to a material having a large heat expansion coefficient for the ball seat. When the temperature increases, the cross-section of the inlet control edge is reduced by way of an annular disk of such a material, which forms the ball seat and is installed without a protective ring.

This embodiment has the additional advantage that the annular disk that forms the ball seat can subsequently be mounted or clipped on as an insert in the pressure control handle, which significantly simplifies the production process.

The known pressure control valves configured as closed-end pressure regulators must allow a high dynamic at the follow-up slide valve, while the leakage must be as low as possible.

The transition from the inlet seat to the tank seat occurs very abruptly so that the leakage volume flow of the pressure regulator increases abruptly without achieving a substantial pressure increase. This is necessary in order to keep the disturbing influences in the reducing pressure as far away as possible from the working pressure, but leads to the disadvantage that a high leakage oil volume is produced in the low pressure range of the pressure regulator, while a high volume flow requirement of the transmission is present at the same time in this pressure range for the purpose of filling the clutch.

The geometric configuration of the ball seat, which is actuated by way of a push rod, essentially determines the maximum leakage or the maximum volume flow of the pressure regulator while, according to the prior art, the cross-section of the inflow edge is reduced by way of the push rod, which has a cylindrical geometry that remains essentially the same when viewed from the axial direction.

When a high pressure and volume flow requirement occurs, the push rod of the pressure regulator is displaced to completely close the tank edge, wherein the maximum volume flow is required in this situation in order to bring the follow-up, slide valve into its control position. When the control position is reached, there is very little or no volume flow requirement at the pressure regulator with reference to the working pressure so that the inlet volume flow at the inlet control edge can be reduced.

According to a further development of the invention, the push rod is consequently configured at its end facing the ball seat such that the opening of cross-section of the inlet edge can be modified depending on the axial position of the push rod, in such a way that the cross-section is reduced when the target pressure is low in order to reduce the inlet volume flow, while the total cross-section of the inlet edge is available when the target pressure is high in order to satisfy the high volume flow requirements of the follow-up, slide valve and to be able to compensate for a high leakage in the working pressure.

Preferably the push rod has a geometric expansion in the area of its end facing the ball seat, which results in a position-dependent, cross-sectional constriction, wherein the pressure/flow/flowthrough behavior of the pressure regulator is determined by the axial position and contour of the geometric expansion. Here the geometric expansion can have the shape of a truncated cone that tapers in the direction of the ball seat or can have a cylindrical, concave or convex shape; a double cone shape is likewise possible.

With this configuration of the push rod, the transition of the inlet control edge to the tank control edge, which is abrupt without the geometric expansion, can be rendered more gentle, whereby a startup jump in the pressure control characteristic is prevented. Further, when the volume flow requirement is low, laminar flow can be converted into turbulent flow in this way, which facilitates the passage of the oil at low temperatures.

As an alternative or in addition to the configuration of the push rod, the ball seat can be designed in such a way that its diameter on the side facing the ball is smaller than its diameter on the side that faces away from the ball. The sharpened shape of the ball seat achieves the effect that laminar flow is converted to turbulent flow, which facilitates the passage of the oil at low temperatures.

### BRIEF DESCRIPTION OF THE DRAWINGS

The invention will now be described, by way of example with reference to the accompanying drawings in which:

FIG. 1 shows a schematic sectional view of a pressure control valve configured as a closed-end pressure regulator according to the prior art;

FIG. 2 shows a schematic sectional view of a part of a pressure control valve configured as a closed-end pressure regulator according to a first embodiment of the present invention;

FIG. 3 shows a schematic sectional view of a further embodiment of a pressure control valve configured as a closed-end pressure regulator;

FIG. 4 shows a diagram comprising a comparison between the pressure volume flow characteristic of a pressure control valve according to the prior art and to the invention;

FIG. 5 shows a schematic sectional view of a further embodiment of a pressure control valve configured as a closed-end pressure regulator according to the invention;

FIG. 6 shows a diagram representing the opening characteristic of the control edges of the valve shown in FIG. 5, and

FIG. 7 shows a diagram representing the pusher position depending on the pressure regulator flow and the pressure regulator force with a valve configured according to the exemplary embodiment of FIG. 5.

### DETAILED DESCRIPTION OF THE INVENTION

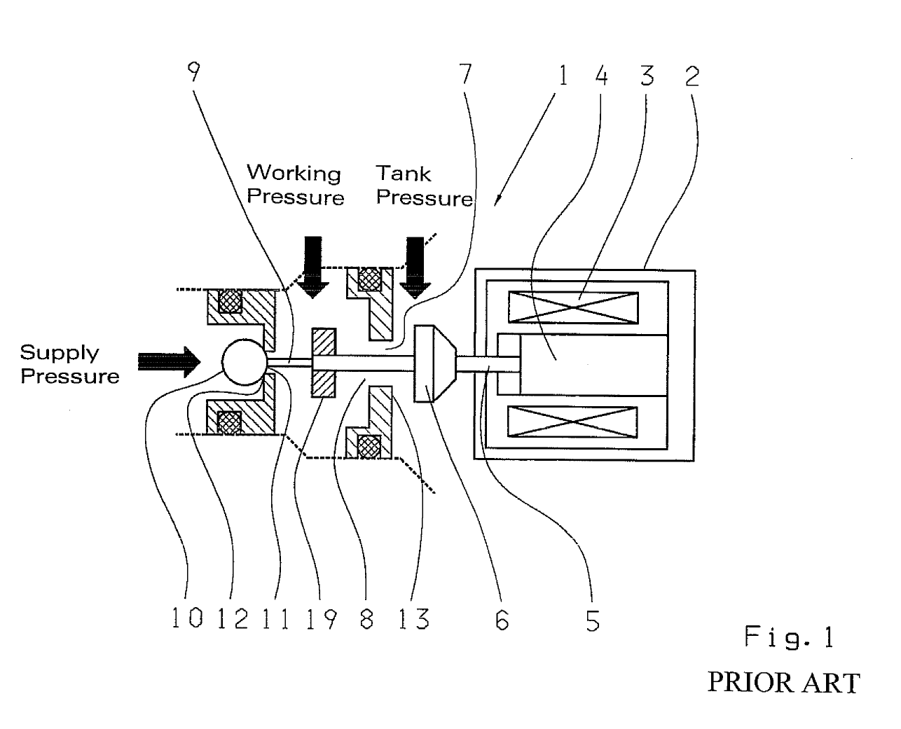

FIG. 1 shows a pressure control valve 1 known from the prior art configured as a closed-end pressure regulator in schematic representation in a depressurized position (inlet control edge is closed) in FIG. 1. These proportional pressure control valves are well known to persons skilled in the art so that in what follows only the parts that are necessary to understand the invention will be described.

The pressure control valve 1 that serves as a precontrol valve has an electromagnet 2, which customarily has a magnetic core, a magnetic coil 3, and an armature 4 that can be displaced toward the left against the Force of a spring, as well as an anchor rod 5, displaceable by the armature 4, for biasing the closing part 6, against a first valve seat preferably designed as a valve seat 7, and can close a through opening 8 incorporated in the valve seat 7. A push rod 9 is also provided, which is connected to the anchor rod 5 or can be designed as a single piece with the anchor rod 5, which can move a sealing element 10 designed as a ball out of a second valve seat designed as a ball seat 11. An inlet control edge is identified with reference numeral 12 and a tank edge is identified with reference numeral 13, while a stream diverter is identified with reference numeral 19.

The valve shown in FIG. 1 has the problem that the inlet volume flow is greatly reduced at low oil temperatures due to the viscous behavior of the oil, which leads to a disadvantageous reduction of the valve dynamic, in particular in precontrolled clutch valves.

In order to avoid this disadvantage, it is proposed according to the invention that the ball seat 11 be made from a material whose heat expansion coefficient is considerably greater than the heat expansion coefficient of the push rod 9, and thus features a disproportionately greater geometric expansion in comparison with the material of the push rod at increasing temperature. The concept, according to the invention, ensures that the cross-section of the inlet control edge 12 has an ever-smaller, cross-section surface at increasing temperature.

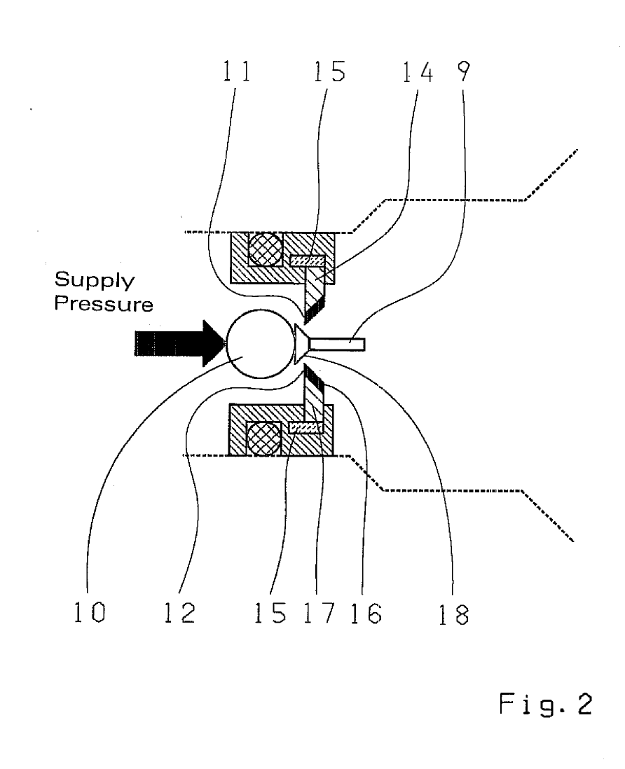

A valve designed in this way is the object of FIG. 2. Here the ball seat 11 is formed by an annular disk 14, wherein a stable supporting ring 15 that is mounted in a fixed manner in a housing is provided on the outer diameter of the disk, by way of which the thermal expansion of the annular disk is guided inwardly as viewed from the radial direction. In an advantageous manner, the supporting ring 15 is made of a material that features the same heat expansion coefficient as the material of the push rod 9, whereby the cross-section of the inlet control edge 12 can be determined solely by selection of the material for the annular disk 14 that forms the ball seat 11. An area of the Figure, which is identified with reference numeral 16, corresponds to the additional expansion of the disk 14 radially inward at high temperature and consequently to the reduction of the cross-section of the inlet control edge 12. A shaded area 17 corresponds to the expansion of the disk 14 at low temperature.

In the example shown in FIG. 2, the push rod 9 is configured in such a way at its end facing the ball seat 11 that the opening cross-section of the inlet control edge 12 can be modified depending on the axial position of the push rod 9 so that the cross-section is reduced when the target pressure is low in order to reduce the inlet volume flow, and the total cross-section of the inlet edge is available when the target pressure is high in order to satisfy the high volume flow requirements of the follow-up slide valve on the one hand, and to be able to compensate for high leakage in the working pressure on the other.

As can be seen in FIG. 2, for this purpose the push rod 9 has a geometric expansion 18 at its end facing the ball seat 11, which has the shape of a truncated cone that tapers in the direction of the ball seat 11 or the electromagnet 2. In addition, the ball seat 11 is designed in such a way in the shown example that its diameter is smaller on the side facing the ball 10 than on the side that faces away from the ball 10. That is, the cross-section of the inlet control edge 12 increases toward the magnetic part 2 of the valve 1 when viewed from the axial direction.

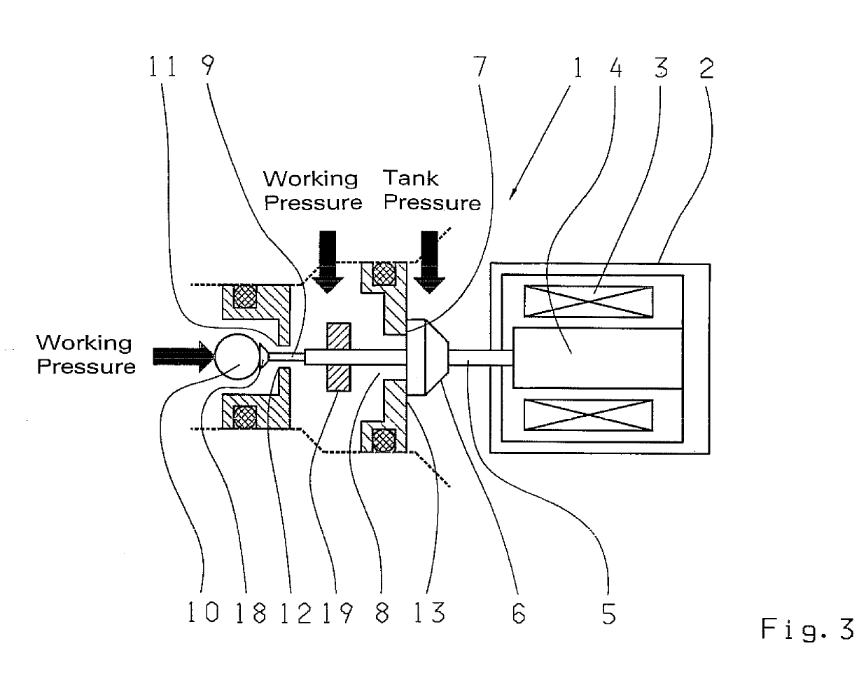

The object of FIG. 3 is an exemplary embodiment of a valve at maximum pressure (tank edge 13 closed, inlet control edge 12 completely open), in which the ball seat 11 is produced according to the prior art, wherein the push rod 9 is designed at its end facing the ball seat 11 according to the embodiment of FIG. 2. Here the full opening cross-section is achieved on the basis of the embodiment of the push rod 9 when the tank edge 13 is completely closed.

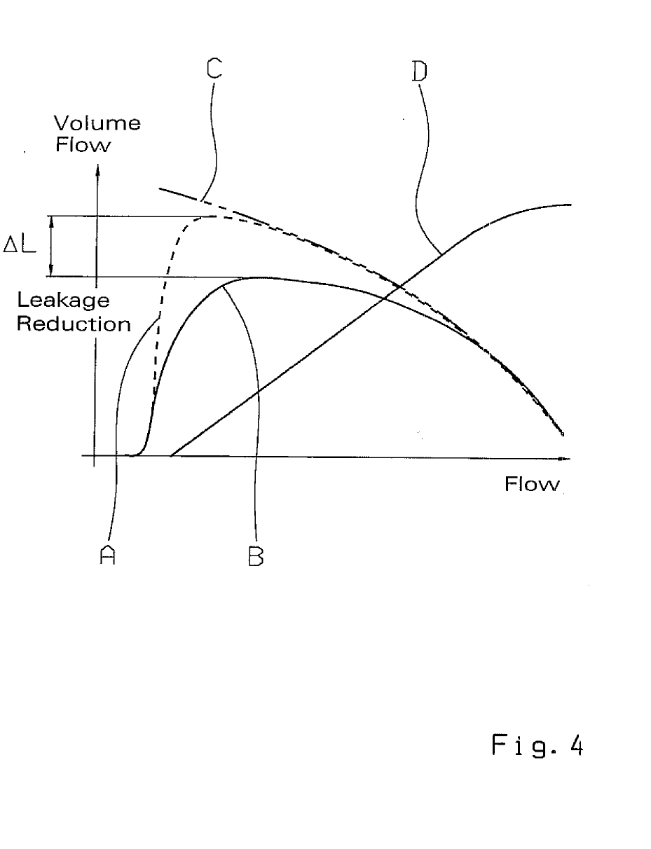

Exemplary pressure/volume flow characteristics of a pressure control valve 1, according to the prior art, and of a pressure control valve 1, designed according to the exemplary embodiment of FIG. 3 are shown in FIG. 4. Here a curve A represents the volume flow depending on the pressure regulator flow for a valve designed according to the example of FIG. 1 with constant inlet geometry, while a curve B represents the volume flow depending on the pressure regulator flow for a valve designed according to the example of FIG. 3 with variable inlet geometry. A curve C furthermore represents the pressure/volume flow characteristic of a conventional pressure control valve without CE-function in which maximum leakage occurs between the inlet edge and the tank edge at a minimum pressure requirement. The working pressure of the valves depending on the pressure regulator flow, is represented by a curve D.

As can be seen in FIG. 4, the leakage of a valve provided with a geometric expansion 18 at the push rod 9, according to the invention, with minimum pressure requirement is significantly reduced in comparison with a conventional valve configured as a closed-end pressure regulator, wherein the difference is identified with ΔL in the Figure. For comparison, a conventional pressure control valve without CE-function has maximum leakage.

It can also be seen in FIG. 4 that the transition from the inlet control edge 12 to the tank edge 13 in a valve provided with the geometric expansion 18 at the push rod 9 can be advantageously rendered more gentle in comparison with a conventional valve configured as the closed-end pressure regulator.

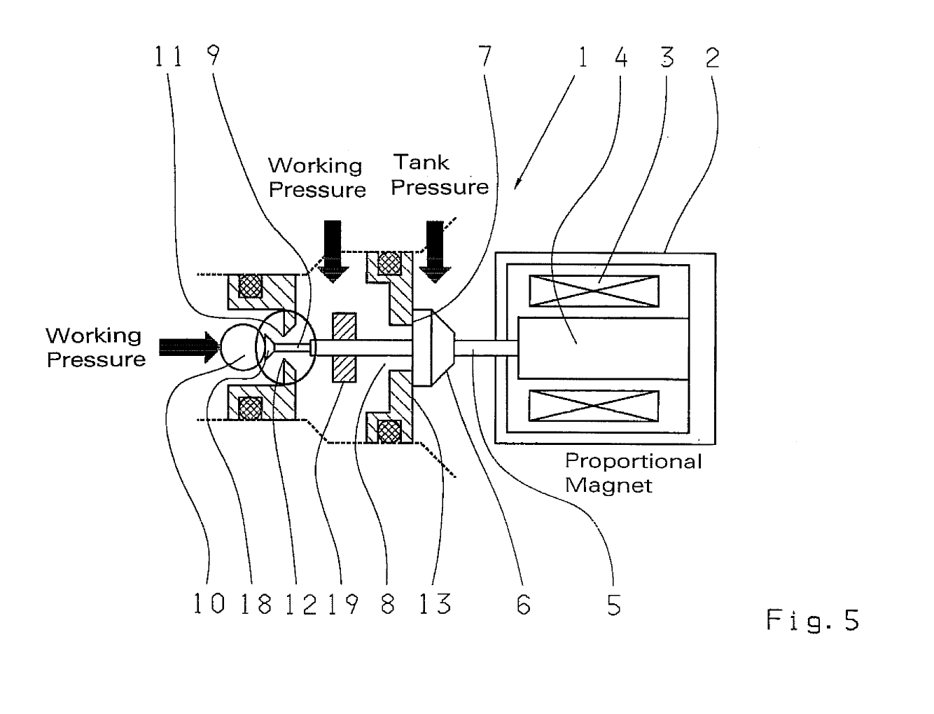

FIG. 5 shows a further exemplary embodiment of a valve, according to the invention in which, in addition to the design of the push rod 9 with the geometric expansion 18, the ball seat 11 is designed in such a way that its diameter on the side facing the ball 10 is smaller than its diameter on the side that faces away from the ball 10; that is, the cross-section of the inlet control edge 12 increases toward the magnetic part 2 of the valve 1 as viewed from the axial direction.

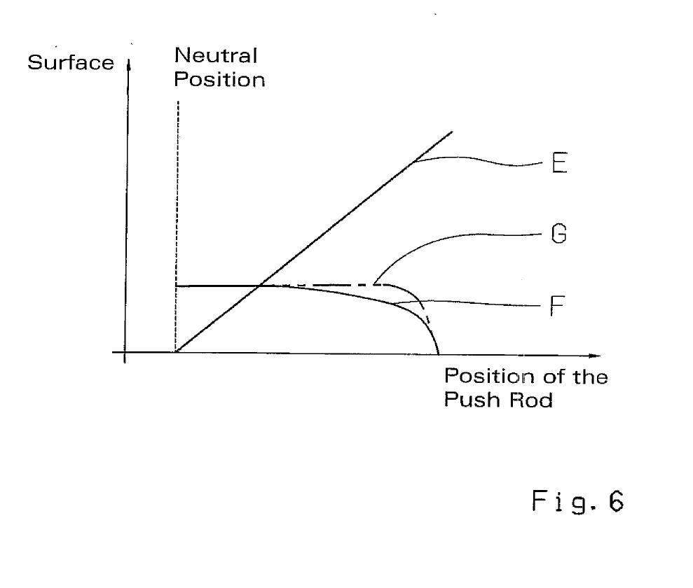

FIG. 6 shows the opening characteristic of the control edges of the valve shown in FIG. 5. Here the tank opening surface is shown by way of a curve E as a function of the position of the push rod 9, while a curve F represents the available cross-sectional surface of the inlet control edge 12 for the valve represented in FIG. 5. For comparison, the available cross-sectional surface of the inlet control edge 12 of a conventional valve configured as a closed-end pressure regulator is shown by a curve G. The tank edge 13 is completely closed in the neutral position and the inlet control edge 12 is completely open.

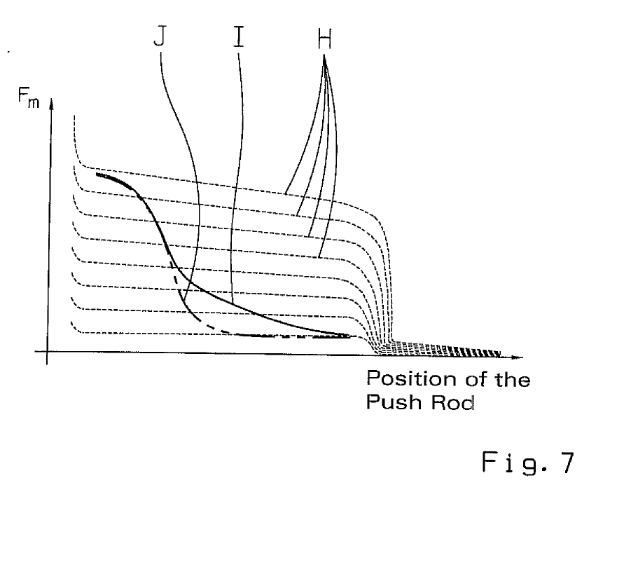

The position of the push rod 9, depending on the pressure regulator flow and a pressure regulator force Fₘ in a conventional valve designed as a closed-end pressure regulator and in a valve according to FIG. 5 is the object of FIG. 7. The position of the push rod 9 results from the target force, which is proportional to the pressure and the sum of the volume flows (the working pressure is constant when the inlet volume flow is equal to the sum of the tank volume flow and the working volume flow).

Here, lines H are lines of force with constant flow. In FIG. 7, a curve I represents the position of the push rod 9 in a valve according to FIG. 5, while a curve J represents the position of the push rod 9 in a conventional valve designed as closed-end pressure regulator.

It goes without saying that any constructive design, in particular any spatial arrangement of the components of the pressure control valve according to the invention, as well as in combination with another, and insofar as it is technically practical, falls under the scope of protection of the claims, without influencing the function of the pressure control valve as disclosed in the claims, even if these designs are not explicitly represented in the Figures or in the description.

### Reference Numerals

1 pressure control valve
2 electromagnet
3 magnetic coil
4 armature
5 anchor rod
6 closing part
7 valve seat
8 opening
9 push rod
10 sealing element
11 ball seat
12 inlet control edge
13 tank edge
14 annular disk
15 supporting ring
16 additional expansion of disk 14
17 expansion of disk 14 at low temperature
18 geometric expansion
19 stream diverter
A volume flow dependent upon the pressure regulator flow for a valve according to the prior art
B volume flow dependent upon the pressure regulator flow for a valve configured according to the invention
C pressure/volume flow characteristic of a conventional pressure control valve without CE-function
D working pressure of the valve dependent upon the pressure regulator flow
E tank opening surface as function of the position of the push rod 9
F available cross-section surface of the inlet control edge as function of the position of the push rod 9 in a valve according to the invention
Fₘ pressure regulation force
G available cross-section surface of the inlet control edge of a conventional valve designed as closed-end pressure regulator
H lines of force with constant flow
I position of the push rod in a valve according to the invention
J position of the push rod in a conventional valve designed as closed-end pressure regulator

1-14. (canceled)

15. A pressure control valve (1) designed as a closed-end pressure regulator, comprising two valve seats (7, 11) arranged in a hydraulic half-bridge circuit, with an electromagnet (2) having a magnetic core, a magnetic coil (3) and an armature (4) with an anchor rod (5) connected thereto, the armature (4) being axially slidable within the electromagnet (2) such that a closing part (6), coupled to the armature (4), being axially slidable to strike a tank edge (13) of a first valve seat (7), a push rod (9), being one of connected to the anchor rod (5) and integrated with the anchor rod (5), biasing a sealing element (10) out of communication with an inlet control edge (12) of a ball seat (11), a cross-section of the inlet control edge (12) of the ball seat (11) being modified depending on temperature such that the cross-section of the inlet control edge (12) of the ball seat (11) being maximized at low oil temperatures to enable passage of a large volume flow, and the cross-section of the inlet control edge (12) of the ball seat (11) being reduced at high oil temperatures such that a high valve dynamic of a follow-up slide valve being achieved and oil flow leakage being essentially uneffected.

16. The pressure control valve according to claim 15, wherein the ball seat (11) is made of a material having a heat expansion coefficient that is greater than a heat expansion coefficient of a material forming the push rod (9) such that the ball seat (11) has a disproportionately stronger geometric expansion in comparison with the push rod (9) at increasing temperatures.

17. The pressure control valve according to claim 15, wherein the ball seat (11) comprises an annular disk (14) that communicates with a stable supporting ring (15), which is mounted in a fixed manner in a housing, on an outer diameter of the annular disk (14) such that the annular disk (14) thermally expands radially inwardly.

18. The pressure control valve according to claim 17, wherein the supporting ring (15) is made of a material having a heat expansion coefficient essentially equal to a heat expansion coefficient of a material forming the push rod (9).

19. The pressure control valve according to claim 16, wherein the annular disk (14) is made of a material having nonlinear heat expansion behavior above a glass transition point.

20. The pressure control valve according to claim 19, wherein the annular disk (14) is made of polyphenylene sulfide.

21. The pressure control valve according to claim 16,wherein the ball seat (11) is produced as an annular disk (14) from a material that has a negative heat expansion coefficient

22. The pressure control valve according to claim 21, wherein the annular disk (14) is made of a fiberglass-reinforced plastic.

23. The pressure control valve according to claim 21, wherein the annular disk (14) is one of mounted and clipped on as insert in a pressure control handle.

24. The pressure control valve according to claim 15, wherein a diameter of the ball seat (11) on a side facing the sealing element (10) is smaller than a diameter of the ball seat (11) on a side facing away from the sealing element (10).

25. The pressure control valve according to claim 15, wherein an end of the push rod (9) adjacent the ball seat (11) is designed such that an opening cross-section of the inlet control edge (12) of the ball seat (11) is modified depending on an axial position of the push rod (9), the cross-section of the inlet control edge (12) of the ball seat (11) is reduced when a target pressure is low to reduce an inlet volume flow, the opening cross-section of the inlet control edge (12) of the ball seat (11) is maximized when the target pressure is high.

26. The pressure control valve according to claim 25, wherein the end of the push rod (9) adjacent the ball seat (11) has a geometric expansion (18).

27. The pressure control valve according to claim 26, wherein the geometric expansion (18) has shape of a truncated cone that tapers inwardly toward the ball seat (11).

28. The pressure control valve according to claim 27, wherein the geometric expansion (18) has one of a cylindrical shaper a concave shape, a convex shape and a double cone shape.
